(19) United States
(12) Patent Application Publication
(10) Pub. No.: US 2025/0085909 A1
(43) Pub. Date: Mar. 13, 2025

(54) MANAGEMENT SYSTEM AND CONTROL METHOD FOR MANAGEMENT DEVICE

(71) Applicant: SEIKO EPSON CORPORATION, Tokyo (JP)

(72) Inventor: Daisuke KURITA, Shiojiri (JP)

(21) Appl. No.: 18/830,692

(22) Filed: Sep. 11, 2024

(30) Foreign Application Priority Data
Sep. 13, 2023 (JP) 2023-148405

(51) Int. Cl. G06F 3/12

(52) U.S. Cl. CPC G06F 3/1239; G06F 3/121; G06F 3/1238

(57) ABSTRACT

There is provided a control method for a management device that manages a storage container that stores a consumable item used in a printing apparatus, the method causing a processor of the management device to function as a granting unit configured to grant a privilege of a first amount to a user who performed a collecting action for collecting the storage container in a first period and grant the privilege of a second amount different from the first amount to the user who performed the collecting action in a second period different from the first period.

The present application is based on, and claims priority from JP Application Serial Number 2023-148405, filed Sep. 13, 2023, the disclosure of which is hereby incorporated by reference herein in its entirety.

### BACKGROUND

### 1. Technical Field

The present disclosure relates to a management system and a control method for a management device.

### 2. Related Art

As disclosed in JP-A-2003-039708, there has been known a method in which collecting a storage container that stores a consumable item used in a printing apparatus and reusing the collected storage container.

JP-A-2003-039708 is an example of the related art.

However, as in the related art, when the storage container is collected and the collected storage container is reused to manufacture the storage container as a recycled product, a problem in that a supply amount of storage containers manufactured as recycled products is insufficient with respect to a demand for storage containers manufactured as recycled products sometimes occurs. For this reason, in the related art, there is room for improvement concerning, for example, the target 12 “ensure a sustainable production mode” among SDGs, that is, the seventeen sustainable development targets adopted in the UN General Assembly on Sep. 25, 2015.

The problem described above is not a problem limited to reuse of a storage container that stores consumable item used in a printing apparatus and is relevant to, for example, a scene of reuse of a reusable member in general.

### SUMMARY

In order to solve the problem described above, a control method for a management device according to the present disclosure is a control method for a management device that manages a storage container that stores a consumable item used in a printing apparatus, the method causing a processor of the management device to function as a granting unit configured to: grant a privilege of a first amount to a user who performed a collecting action for collecting the storage container in a first period; and grant the privilege of a second amount different from the first amount to the user who performed the collecting action in a second period different from the first period.

A management system according to the present disclosure is a management system that manages a reusable specific member, the management system including a granting unit configured to grant a privilege of a first amount to a user who performed a collecting action for collecting the specific member in a first period and grant the privilege of a second amount different from the first amount to the user who performed the collecting action in a second period different from the first period.

### BRIEF DESCRIPTION OF THE DRAWINGS

FIG. 1 is a block diagram illustrating an example of a configuration of a management system according to an embodiment of the present disclosure.

FIG. 2 is a block diagram illustrating an example of a configuration of a cartridge.

FIG. 3 is a block diagram illustrating an example of a configuration of a user card.

FIG. 4 is a block diagram illustrating an example of a configuration of a collection box.

FIG. 5 is a block diagram illustrating an example of a configuration of a management server.

FIG. 6 is a flowchart illustrating an example of an operation of the management system in the case in which point grant rate determination processing is executed.

FIG. 7 is a diagram illustrating a first numerical value example corresponding to the point grant rate determination processing.

FIG. 8 is a diagram illustrating a first numerical value example corresponding to the point grant rate determination processing.

FIG. 9 is a diagram illustrating a second numerical value example corresponding to point grant rate determination processing according to a reference example.

FIG. 10 is a diagram illustrating the second numerical value example corresponding to the point grant rate determination processing according to the reference example.

FIG. 11 is a sequence chart illustrating an example of an operation of the management system in the case in which bringing time point grant processing is executed.

FIG. 12 is a sequence chart illustrating an example of an operation of the management system in the case in which mailing time point grant processing is executed.

### DESCRIPTION OF EMBODIMENTS

A mode for carrying out the present disclosure is explained below with reference to the drawings. In the respective figures, dimensions and scales of units are differentiated from actual one as appropriate. Since embodiments explained below are preferred specific examples of the present disclosure, the embodiments are added with various technically desirable limitations. However, the scope of the present disclosure is not limited to these embodiments unless there is particularly a description to the effect that the present disclosure is limited.

### A. Embodiment

In an embodiment, a management system Sys that manages a cartridge 7 that stores ink used in a printing apparatus PR is explained as an example.

### 1. Configuration of the Management System

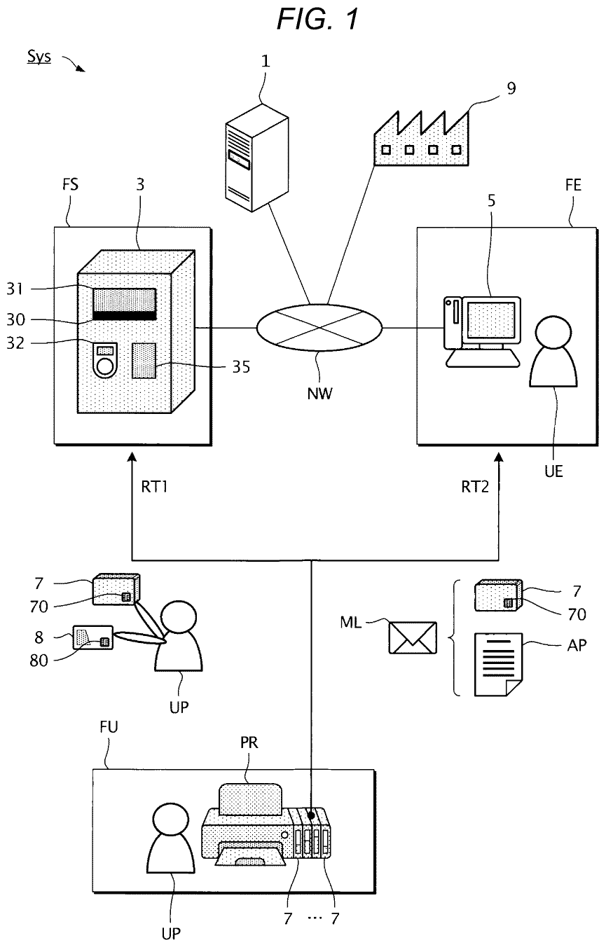

In the following explanation, an example of a configuration of the management system Sys according to the present embodiment is explained with reference to FIGS. 1 to 5.

FIG. 1 is a block diagram illustrating the example of the configuration of the management system Sys.

As illustrated in FIG. 1, the management system Sys includes a management server 1, one or a plurality of collection boxes 3, one or a plurality of collection reception terminals 5, and a recycling factory 9 and manages the cartridge 7 that stores ink used in a printing apparatus PR.

The management server 1 is a server device for managing the cartridge 7. Here, the cartridge 7 is a container that stores the ink used in the printing apparatus PR and is a container that can be attached to the printing apparatus PR.

In the present embodiment, the management server 1 is an example of a “management device”, the ink is an example of a “consumable item”, and the cartridge 7 is an example of a “storage container”.

The collection box 3 is equipment for collecting the used cartridge 7 from a user UP of the printing apparatus PR. Here, the used cartridge 7 is, for example, the cartridge 7 in which a residual amount of the ink stored therein is small or the cartridge 7 in which the ink stored therein is deteriorated. That is, in the present embodiment, even if the ink remains inside the cartridge 7, the collection box 3 can collect the cartridge 7.

In the present embodiment, the collection box 3 is installed in a commercial facility FS. Here, the commercial facility FS is a commercial facility such as an electronics retail store that sells the printing apparatus PR or a shopping mall that sells various commodities, a public facility such as a public hall, a medical facility such as a hospital, or the like.

In the present embodiment, the collection box 3 is an example of “collection equipment”.

The collection reception terminal 5 is a terminal device provided in a collection center FE. Specifically, when the user UP of the printing apparatus PR mails the used cartridge 7 to the collection center FE, the collection reception terminal 5 is a terminal device for a staff member UE of the collection center FE inputting information concerning the cartridge 7 mailed by the user UP. The collection center FE is a facility for collecting the used cartridge 7 from the user UP of the printing apparatus PR.

In the present embodiment, the collection center FE is another example of the “collection equipment”.

The recycling factory 9 is a facility for recycling the used cartridge 7 collected from the user UP in the collection box 3 or the collection center FE to reproduce the used cartridge 7 as a recycled product. Specifically, the recycling factory 9 is a facility that cleans the used cartridge 7 and then refills the cleaned cartridge 7 with ink to manufacture “a recycled product of the cartridge 7” obtained by recycling the used cartridge 7. However, the recycling factory 9 may disassemble the used cartridge 7 into materials and then use the disassembled materials to manufacture the recycled product of the cartridge 7. The recycling factory 9 may disassemble the used cartridge 7 into materials and then use the disassembled materials to manufacture a commodity different from the cartridge 7 as a recycled product.

In the present embodiment, it is assumed that the printing apparatus PR is provided in a user facility FU. Here, the user facility FU is a facility where the user UP uses the printing apparatus PR, such as a home of the user UP or an office of the user UP.

In the present embodiment, as an example, it is assumed that there are two collection routes, that is, a user bringing collection route RT1 and a mailing collection route RT2, as collection routes for the used cartridge 7.

The user bringing collection route RT1 is a route through which the user UP brings the cartridge 7 used in the user facility FU to the collection box 3 provided in the commercial facility FS and the used cartridge 7 is collected from the user UP. Note that, in the present embodiment, it is assumed that, when the used cartridge 7 is collected through the user bringing collection route RT1, as an example, when the user UP puts the used cartridge 7 in the collection box 3, authentication for the user UP is performed by a user card 8 carried by the user UP.

In the present embodiment, an action of the user UP bringing the cartridge 7 to the collection box 3 of the commercial facility FS is an example of a “collecting action”.

The mailing collection route RT2 is a route for mailing the used cartridge 7 from the user facility FU to the collection center FE to collect the used cartridge 7 from the user UP. In the present embodiment, it is assumed that, when the used cartridge 7 is collected from the mailing collection route RT2, as an example, the user UP sends a mail ML enclosing the used cartridge 7 and a collection application AP to the collection center FE.

In the present embodiment, the action of the user UP mailing the cartridge 7 to the collection center FE is another example of the “collecting action”.

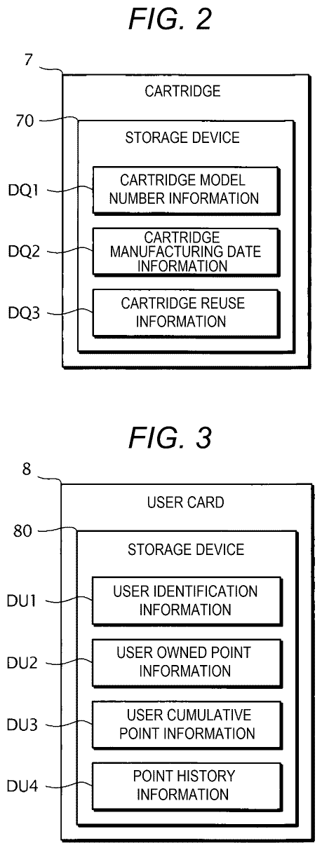

FIG. 2 is a block diagram illustrating an example of a configuration of the cartridge 7.

As illustrated in FIG. 2, the cartridge 7 includes a storage device 70. The cartridge 7 is provided with an ink storage chamber (not illustrated) that stores ink.

The storage device 70 is, for example, an IC chip and stores cartridge model number information DQ1, cartridge manufacturing date information DQ2, and cartridge reuse information DQ3.

The cartridge model number information DQ1 is information indicating a model number of a product of the cartridge 7.

The cartridge manufacturing date information DQ2 is information indicating a date of manufacture of the cartridge 7.

The cartridge reuse information DQ3 is information indicating the number of times the cartridge 7 is recycled as a recycled product. Specifically, the cartridge reuse information DQ3 indicates “0” when the cartridge 7 is a new product before recycling and indicates a numerical value of “1” or more when the cartridge 7 is a recycled product.

FIG. 3 is a block diagram illustrating an example of a configuration of the user card 8.

As illustrated in FIG. 3, the user card 8 includes a storage device 80 that stores information concerning points usable by the user UP.

In the present embodiment, it is assumed that, when the user UP purchases a recycled product of the cartridge 7, a part or all of an amount of the purchase can be replaced with a point. In the present embodiment, it is assumed that, when the user UP has purchased a commodity in the commercial facility FS, a part or all of an amount of the purchase can be replaced with a point. That is, in the present embodiment, it is assumed that the point is exchangeable with the recycled product of the cartridge 7 and the point is exchangeable with a commodity that can be purchased in the commercial facility FS. However, the present disclosure is not limited to such an aspect. The point only has to be at least exchangeable with a recycled product of the cartridge 7.

Further, in the present embodiment, the point is granted to the user UP when the user UP has brought the used cartridge 7 into the collection box 3, when the user UP has mailed the used cartridge 7 to the collection center FE, and when the user UP has purchased a commodity in the commercial facility FS. However, the present disclosure is not limited to such an aspect. The point only has to be granted to the user UP at least when the user UP has brought the used cartridge 7 into the collection box 3 and when the user UP has mailed the used cartridge 7 to the collection center FE. That is, the point only has to be granted to the user UP at least when the user UP has performed the collecting action.

In the present embodiment, the point is an example of a “privilege”.

The storage device 80 is, for example, an IC chip and stores user identification information DU1, user owned point information DU2, user cumulative point information DU3, and point history information DU4.

The user identification information DU1 is information indicating a user ID for uniquely identifying each user out of a plurality of users who own user cards 8. In the present embodiment, it is assumed that a user who owns the user card 8 is the user UP who uses the printing apparatus PR. However, the present disclosure is not limited to such an aspect. The user who owns the user card 8 may be the user UP who uses the printing apparatus PR and a user who uses the commercial facility FS. The user who owns the user card 8 may be a user who uses the cartridge 7.

The user owned point information DU2 is information indicating the number of points owned by the user UP. Here, the number of points is a quantity of points.

The user cumulative point information DU3 is information indicating a cumulative value of the number of points acquired by the user UP from the start of management of the user UP by the management system Sys to the present. Here, the management of the user UP by the management system Sys may be started, for example, at timing when the user UP purchases the printing apparatus PR. The management of the user UP by the management system Sys may be started, for example, at timing when the user UP purchases the cartridge 7.

The point history information DU4 is information indicating a history of granting points to the user UP and a history of use of points by the user UP in a period from the start of the management of the user UP by the management system Sys to the present.

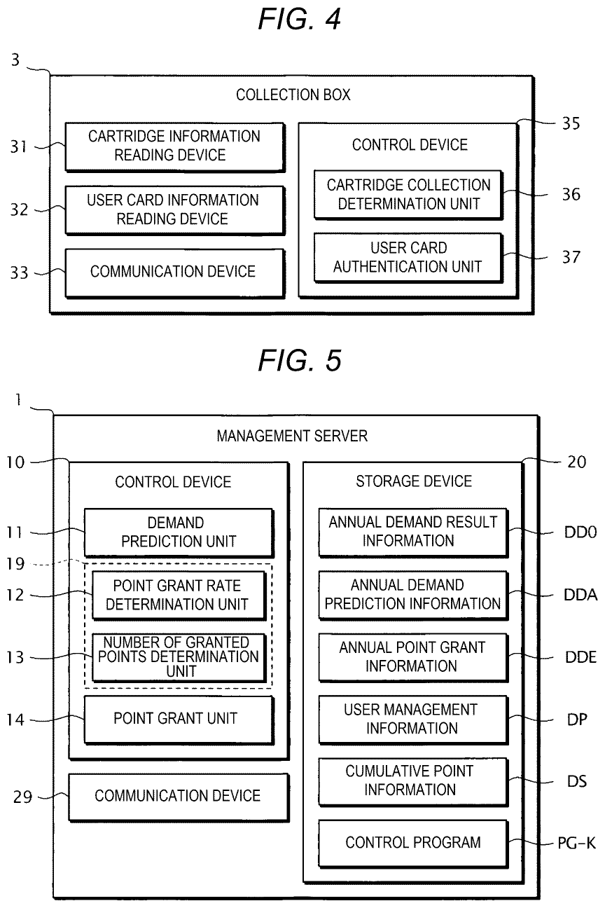

FIG. 4 is a block diagram illustrating an example of a configuration of the collection box 3.

As illustrated in FIGS. 1 and 4, the collection box 3 includes a cartridge insertion slot 30, a cartridge information reading device 31, a user card information reading device 32, a communication device 33, and a control device 35.

The cartridge insertion slot 30 is an opening for the user UP to insert the cartridge 7 into a cartridge storage space (not illustrated) provided inside the collection box 3.

When the cartridge 7 is inserted into the cartridge insertion slot 30, the cartridge information reading device 31 reads, from the storage device 70 provided in the cartridge 7, the cartridge model number information DQ1, the cartridge manufacturing date information DQ2, and the cartridge reuse information DQ3 stored in the storage device 70. However, the present disclosure is not limited to such an aspect. When the cartridge 7 is inserted into the cartridge insertion slot 30, the cartridge information reading device 31 only has to read at least the cartridge model number information DQ1 stored in the storage device 70 from the storage device 70 provided in the cartridge 7.

When the user UP touches the user card information reading device 32 with the user card 8, the user card information reading device 32 reads, from the storage device 80 provided in the user card 8, the user identification information DU1, the user owned point information DU2, the user cumulative point information DU3, and the point history information DU4 stored in the storage device 80. However, the present disclosure is not limited to such an aspect. When the user UP touches the user card information reading device 32 with the user card 8, the user card information reading device 32 only has to read at least the user identification information DU1 from the storage device 80 provided in the user card 8.

The communication device 33 is hardware for communicating with, via one or both of a wired network and a wireless network, an external device present outside the collection box 3.

The control device 35 includes a cartridge collection determination unit 36 and a user card authentication unit 37.

The cartridge collection determination unit 36 determines, based on a reading result by the cartridge information reading device 31, whether an object inserted into the cartridge insertion slot 30 corresponds to the cartridge 7 that can be collected by the collection box 3. Specifically, the cartridge collection determination unit 36 determines whether a model number indicated by the cartridge model number information DQ1 read by the cartridge information reading device 31 is a model number corresponding to the cartridge 7 that can be collected by the collection box 3.

When the model number indicated by the cartridge model number information DQ1 read by the cartridge information reading device 31 is the model number corresponding to the cartridge 7 that can be collected by the collection box 3, the cartridge collection determination unit 36 determines that the object inserted into the cartridge insertion slot 30 corresponds to the cartridge 7 that can be collected by the collection box 3. When the model number indicated by the cartridge model number information DQ1 read by the cartridge information reading device 31 is not the model number corresponding to the cartridge 7 that can be collected by the collection box 3, the cartridge collection determination unit 36 determines that the object inserted into the cartridge insertion slot 30 does not correspond to the cartridge 7 that can be collected by the collection box 3. When the cartridge information reading device 31 has failed in reading the cartridge model number information DQ1, the cartridge collection determination unit 36 determines that the object inserted into the cartridge insertion slot 30 does not correspond to the cartridge 7 that can be collected by the collection box 3.

When a result of the determination by the cartridge collection determination unit 36 is affirmative, that is, when the object inserted into the cartridge insertion slot 30 corresponds to the cartridge 7 that can be collected by the collection box 3, the collection box 3 stores the cartridge 7 in the cartridge storage space in the collection box 3. On the other hand, when the result of the determination by the cartridge collection determination unit 36 is negative, that is, when the object inserted into the cartridge insertion slot 30 does not correspond to the cartridge 7 that can be collected by the collection box 3, the collection box 3 discharges the object to the outside of the collection box 3.

When the user card information reading device 32 is touched by the user card 8, the user card authentication unit 37 specifies, based on the user identification information DU1 stored in the storage device 80 provided in the user card 8, a user ID of the user UP who owns the user card 8.

FIG. 5 is a block diagram illustrating an example of a configuration of the management server 1.

As illustrated in FIG. 5, the management server 1 includes a control device 10, a storage device 20, and a communication device 29.

The communication device 29 is hardware for communicating with, via one or both of a wired network and a wireless network, an external device present outside the management server 1.

The storage device 20 includes a volatile memory such as a RAM (Random Access Memory) functioning as a work area of the control device 10 and a nonvolatile memory such as an EEPROM (Electrically Erasable Programmable Read-Only Memory) that stores various information. In the present embodiment, the storage device 20 stores annual demand result information DD0, annual demand prediction information DDA, annual point grant information DDE, user management information DP, cumulative point information DS, and a control program PG-K for controlling the units of the management server 1.

The annual demand result information DD0 is information indicating a result of demand for the cartridge 7 managed by the management system Sys in a predetermined period in the past. Here, in the present embodiment, as an example, it is assumed that the predetermined period is “one year”. That is, in the present embodiment, it is assumed that the predetermined period in the past is one year in the past. Specifically, in the present embodiment, as an example, it is assumed that the predetermined period in the past is one year from January to December of the last year. That is, in the present embodiment, the annual demand result information DD0 indicates a result value of the demand for the cartridge 7 in one year from January to December of the last year.

In the following explanation, one year, which is the predetermined period, is sometimes divided into M unit periods. Here, a value M is a natural number that satisfies 1≤M. Specifically, in the present embodiment, as an example, it is assumed that the unit period is “one month”. That is, in the present embodiment, as an example, it is assumed that “M=12”.

In the following explanation, among the M unit periods forming the predetermined period, information corresponding to an m-th unit period is sometimes represented by adding a suffix [m]. Here, a variable m is a natural number satisfying 1≤m≤M″. In the following explanation, the m-th unit period is sometimes referred to as “m month”.

In the present embodiment, the annual demand result information DD0 includes M pieces of demand result information D0[1] to D0[M] corresponding to the M unit periods. Demand result information D0[m] is information indicating a demand result value S0[m], which is a result value of demand for the cartridge 7 in the m-th unit period.

The annual demand prediction information DDA is information indicating a predicted value of demand for the cartridge 7 in a predetermined period including the present. Specifically, in the present embodiment, as an example, it is assumed that the predetermined period including the present is one year from January to December of this year. That is, in the present embodiment, the annual demand prediction information DDA indicates a predicted value of demand for the cartridge 7 in one year from January to December of this year.

In the present embodiment, the annual demand prediction information DDA includes M pieces of demand prediction information DA[1] to DA[M] corresponding to the M unit periods. Among the M pieces of demand prediction information DA[1] to DA[M], a demand prediction information DA[m] is information indicating a demand predicted value SA[m], which is a predicted value of demand for the cartridge 7 in the m-th unit period.

The annual point grant information DDE is information indicating a grant rate of a point granted to the user UP in the predetermined period including the present. In the present embodiment, it is assumed that the grant rate of a point granted to the user UP is individually determined for each unit period.

In the present embodiment, the annual point grant information DDE includes M pieces of point grant rate information DE[1] to DE[M] corresponding to the M unit periods. Among the M pieces of point grant rate information DE[1] to DE[M], point grant rate information DE[m] is information indicating a grant rate of a point granted to the user UP in the m-th unit period. In the following explanation, a point grant rate indicated by the point grant rate information DE[m] is referred to as point grant rate SE[m].

The user management information DP is information including information indicating a user ID for identifying the user UP, information indicating the number of points owned by the user UP, information indicating a history of points granted to the user UP, information indicating a history of points used by the user UP, and information indicating a cumulative value of points granted to the user UP. That is, the user management information DP is information indicating the same contents as the user identification information DU1, the user owned point information DU2, the user cumulative point information DU3, and the point history information DU4.

In the present embodiment, the user management information DP is an example of “history information”.

In the present embodiment, as an example, it is assumed that the storage device 80 stores the user identification information DU1, the user owned point information DU2, the user cumulative point information DU3, and the point history information DU4 and the storage device 20 stores the user management information DP. However, the present disclosure is not limited to such an aspect. For example, the storage device 80 only has to store at least the user identification information DU1 indicating the user ID and may not store the user owned point information DU2, the user cumulative point information DU3, and the point history information DU4.

In the present embodiment, it is assumed that the management system Sys grants a point to the user UP when a cumulative value of the number of points acquired by the user UP satisfies a specific condition in addition to the management system Sys granting a point to the user UP when the user UP performs a collecting action.

In the following explanation, the cumulative value of the number of points acquired by the user UP is sometimes referred to as cumulative acquired point. In the following explanation, the point granted to the user UP when the cumulative value of the number of points acquired by the user UP satisfies the specific condition is sometimes referred to as cumulative granted point.

The cumulative point information DS is information that specifies a relation between the cumulative acquired point owned by the user UP and a quantity of the cumulative granted point to be granted to the user UP. Specifically, the cumulative point information DS may be information indicating a specific condition that the cumulative acquired point should satisfy in order to grant the cumulative granted point to the user UP. Here, the specific condition may be, for example, a condition that the cumulative acquired point has a specific value or a condition that the cumulative acquired point is a multiple of a specific value.

The control device 10 includes a processor. The processor of the control device 10 includes, for example, one or a plurality of CPUs (Central Processing Units). In the present embodiment, the processor of the control device 10 can function as a demand prediction unit 11, a point grant rate determination unit 12, a number of granted points determination unit 13, and a point grant unit 14 by executing the control program PG-K stored in the storage device 20 and operating according to the control program PG-K. The processor of the control device 10 may include hardware such as a GPU (Graphics Processing Unit), a DSP (Digital Signal Processor), or an FPGA (Field Programmable Gate Array) in addition to the one or the plurality of CPUs or instead of a part or all of the one or the plurality of CPUs. In this case, a part or all of functions implemented by the processor of the control device 10 may be implemented by the hardware such as the DSP.

The demand prediction unit 11 predicts demand for the cartridge 7.

Specifically, in the present embodiment, before one predetermined period is started, the demand prediction unit 11 generates the annual demand prediction information DDA in the one predetermined period based on the annual demand result information DD0 in another predetermined period preceding the one predetermined period. That is, in the present embodiment, the demand prediction unit 11 predicts demand for the cartridge 7 of this year based on, for example, a result of demand for the cartridge 7 of the previous year. However, the present disclosure is not limited to such an aspect. The demand prediction unit 11 may predict demand for the cartridge 7 this and subsequent years based on a result of demand for the cartridge 7 over a plurality of years in the past. In the present embodiment, for simplicity, it is assumed that the demand prediction unit 11 sets the demand predicted value SA[m] indicated by the demand prediction information DA[m] to the same value as the demand result value S0[m] indicated by the demand result information D0[m].

The point grant rate determination unit 12 generates the annual point grant information DDE based on the annual demand prediction information DDA.

The number of granted points determination unit 13 determines, based on the point grant rate information DE[m] included in the annual point grant information DDE, the number of points granted to the user UP. Specifically, in the present embodiment, when the used cartridge 7 is collected from the user UP, the number of granted points determination unit 13 determines, as the number of points granted to the user UP, an integrated value of a sales price of the cartridge 7 collected from the user UP and the point grant rate SE[m] indicated by the point grant rate information DE[m]. The number of granted points determination unit 13 determines, based on the cumulative acquired point of the user UP indicated by the user management information DP and the cumulative point information DS, the number of points granted to the user UP.

In the present embodiment, the point grant rate determination unit 12 and the number of granted points determination unit 13 are referred to as point determination unit 19. In the present embodiment, the point determination unit 19 is an example of a “determination unit”.

The point grant unit 14 grants, to the user UP, a point of the number of points determined by the number of granted points determination unit 13. Then, the point grant unit 14 updates the user management information DP when the point grant unit 14 grands a point to the user UP and when the user UP uses a point. In the following explanation, information indicating the number of points granted to the user UP by the point grant unit 14 is sometimes referred to as granted point information DX.

In the present embodiment, the point grant unit 14 is an example of a “granting unit”.

### 2. Point Grant Rate Determination Processing

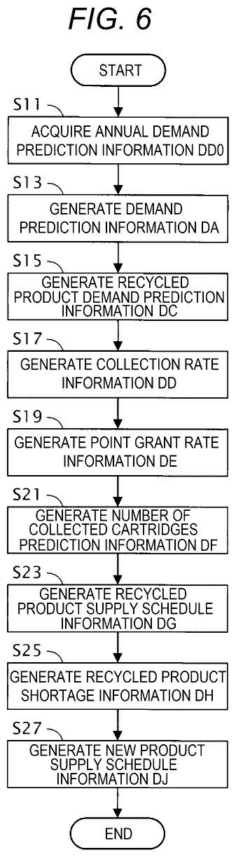

In the following explanation, an example of point grant rate determination processing is explained with reference to FIG. 6. Here, the point grant rate determination processing is processing of generating the annual point grant information DDE.

FIG. 6 is a flowchart illustrating an example of an operation of the management system Sys in the case in which the management system Sys performs the point grant rate determination processing.

As illustrated in FIG. 6, in the point grant rate determination processing, first, the demand prediction unit 11 provided in the management server 1 acquires the annual demand result information DD0 from the storage device 20 (S11). In the present embodiment, it is assumed that the management server 1 generates the annual demand result information DD0 before executing the point grant rate determination processing and causes the storage device 20 to store the generated annual demand result information DD0.

Subsequently, the demand prediction unit 11 generates the annual demand prediction information DDA based on the annual demand result information DD0 acquired in step S11 (S13).

Specifically, in step S13, the demand prediction unit 11 generates the annual demand prediction information DDA by setting the demand predicted value SA[m] indicated by the demand prediction information DA[m] to the same value as the demand result value S0[m] indicated by the demand result information D0[m].

Subsequently, the point grant rate determination unit 12 generates new product annual demand prediction information DDB and recycled product annual demand prediction information DDC based on the annual demand prediction information DDA (S15).

The new product annual demand prediction information DDB is information indicating a predicted value of demand for a new product of the cartridge 7 in a predetermined period including the present. In the present embodiment, the new product annual demand prediction information DDB includes M pieces of new product demand prediction information DB[1] to DB[M] corresponding to the M unit periods. Among the M pieces of new product demand prediction information DB[1] to DB[M], new product demand prediction information DB[m] is information indicating a new product demand predicted value SB[m], which is a predicted value of demand for the new cartridge 7 in the m-th unit period.

In the present embodiment, as an example, an assumption that a relation of the following Expression (1) holds between the demand predicted value SA[m] indicated by the demand prediction information DA[m] and the new product demand predicted value SB[m] indicated by the new product demand prediction information DB[m] is introduced. Here, a new product demand rate a is a real number that satisfies “0<α<1”.

$$SB [ m ] = α * SA [ m ] \qquad ( 1 )$$

For this reason, in the present embodiment, as an example, it is assumed that the point grant rate determination unit 12 generates the new product demand prediction information DB[m] by setting, as the new product demand predicted value SB[m], a value obtained by integrating the demand predicted value SA[m] indicated by the demand prediction information DA[m] and the new product demand rate a.

The recycled product annual demand prediction information DDC is information indicating a predicted value of demand for a recycled product of the cartridge 7 in a predetermined period including the present. In the present embodiment, the recycled product annual demand prediction information DDC includes M pieces of recycled product demand prediction information DC[1] to DC[M] corresponding to the M unit periods. The recycled product demand prediction information DC[m] is information indicating the recycled product demand predicted value SC[m], which is a predicted value of demand for a recycled product of the cartridge 7 in the m-th unit period.

In the present embodiment, as an example, an assumption that the following Expression (2) holds between the demand predicted value SA[m] indicated by the demand prediction information DA[m] and the recycled product demand predicted value SC[m] indicated by the recycled product demand prediction information DC[m] is introduced.

$$S C [ m ] = ( 1 - α ) * SA [ m ] \qquad ( 2 )$$

Therefore, in the present embodiment, as an example, it is assumed that, in step S15, the point grant rate determination unit 12 generates the recycled product demand prediction information DC[m] by setting, as the recycled product demand predicted value SC[m], an integrated value of the demand predicted value SA[m] indicated by the demand prediction information DA[m] and the value “1−α” obtained by subtracting the new product demand rate α from “1”.

However, in the present embodiment, it is assumed that, in step S15, the point grant rate determination unit 12 generates the new product annual demand prediction information DDB and the recycled product annual demand prediction information DDC. However, the present disclosure is not limited to such an aspect. The point grant rate determination unit 12 may generate one of the new product annual demand prediction information DDB and the recycled product annual demand prediction information DDC in step S15.

Subsequently, the point grant rate determination unit 12 generates annual collection rate information DDD based on the annual demand prediction information DDA and the recycled product annual demand prediction information DDC (S17).

The annual collection rate information DDD is information indicating a ratio of cartridges 7 to be collected by the management system Sys to demand for cartridges 7. In other words, the annual collection rate information DDD is information indicating a ratio of cartridges 7 that need to be collected by a collecting action without being discarded among cartridges 7 purchased by the user UP.

In the present embodiment, as an example, an assumption that purchase of the cartridge 7 by the user UP and discarding and collection of the used cartridge 7 by the user UP are carried out in the same unit period is introduced. That is, in the present embodiment, as an example, an assumption that, when purchase of the cartridge 7 by the user UP is performed in the m-th unit period, discarding or collection of the used cartridge 7 after the user UP uses the cartridge 7 is carried out in the m-th unit period is introduced.

In the present embodiment, as an example, an assumption that a time length equivalent to the unit period is required from a collecting action by the user UP to transfer of the used cartridge 7 collected from the collecting action to the recycling factory 9 is introduced. That is, in the present embodiment, as an example, an assumption that, when the collecting action by the user UP is carried out in the m-th unit period, the transfer of the used cartridge 7 collected by the collecting action to the recycling factory 9 is carried out in a (m+1)-th unit period is introduced.

In the present embodiment, as an example, an assumption that a time length equivalent to the unit period is required from when the used cartridge 7 is transferred to the recycling factory 9 until a recycled product of the cartridge 7 obtained by recycling the used cartridge 7 is supplied to the market is introduced. That is, in the present embodiment, as an example, an assumption that, when the transfer of the used cartridge 7 to the recycling factory 9 is carried out in the (m+1)-th unit period, the supply of the recycled product of the cartridge 7 obtained by recycling the used cartridge 7 to the market is carried out in a (m+2)-th unit period is introduced.

In the present embodiment, an assumption that a demand amount of the cartridge 7 in a m-th predetermined period in one predetermined period and a demand amount of the cartridge 7 in the m-th predetermined period of in another predetermined period are similar is introduced. Specifically, in the present embodiment, an assumption that a demand amount of the cartridge 7 in the m month of a certain year and a demand amount of the cartridge 7 in the m month of another one year are similar is introduced. For this reason, in the present embodiment, for example, when “(m+1)>M”, the (m+1)-th unit period is sometimes read as (m+1-M)-th unit period and, when “(m+2)>M”, the (m+2)-th unit period is sometimes read as (m+2-M)-th unit period. Specifically, in the present embodiment, for example, when the m-th unit period is “December”, the (m+1)-th unit period is sometimes regarded as “January” and the (m+2)-th unit period is sometimes regarded as “February”.

In the present embodiment, the annual collection rate information DDD includes M pieces of collection rate information DD[1] to DD[M] corresponding to the M unit periods. Among the M pieces of collection rate information DD[1] to DD[M], collection rate information DD[m] is information indicating a collection rate SD[m], which is a ratio of cartridges 7 to be collected by the management system Sys to demand for cartridges 7 in the m-th unit period.

In the present embodiment, as explained above, the cartridge 7 collected in the m-th unit period is resupplied to the market as a recycled product of the cartridge 7 in the (m+2)-th unit period. For this reason, in the present embodiment, in step S17, the point grant rate determination unit 12 determines the collection rate SD[m] based on the demand prediction information DA[m] indicating the predicted value of the demand for the cartridge 7 in the m-th unit period and the recycled product demand prediction information DC[m+2] indicating the predicted value of the demand for the recycled product of the cartridge 7 in the (m+2)-th unit period. Specifically, as illustrated in the following Expression (3), the point grant rate determination unit 12 calculates the collection rate SD[m] based on the recycled product demand predicted value SC[m+2], which is the predicted value of the demand for the recycled product of the cartridge 7 in the (m+2)-th unit period, and the demand predicted value SA[m], which is the predicted value of the demand for the cartridge 7 in the m-th unit period.

$$S D [ m ] = S C [ m + 2 ] \div SA [ m ] \qquad ( 3 )$$

As explained above, in the present embodiment, the collection rate of the used cartridge 7 in the m-th unit period is set based on the predicted value of the demand for the recycled product of the cartridge 7 in the (m+2)-th unit period. For this reason, according to the present embodiment, it is possible to set a supply amount of the recycled product of the cartridge 7 to the market in the (m+2)-th unit period corresponding to the demand amount of the recycled product of the cartridge 7 in the (m+2)-th unit period.

Subsequently, the point grant rate determination unit 12 generates the annual point grant information DDE based on the annual collection rate information DDD (S19).

In the present embodiment, an assumption that, when the point grant rate SE[m] in the m-th unit period is high, the collection rate SD[m] in the m-th unit period is higher compared with when the point grant rate SE[m] is low is introduced. Further, in the present embodiment, an assumption that a relation of the following expression (4) is established between the collection rate SD[m] and the point grant rate SE[m]. The value λ appearing in the following Equation (4) is a real number satisfying “λ>0”.

$$S D [ m ] = λ * SE [ m ] \qquad ( 4 )$$

In this embodiment, in step S19, the point grant rate determination unit 12 determines the point grant rate SE[m] based on the collection rate SD[m] as in the following Expression (5) to generate the annual point grant information DDE. A value p appearing in the following Expression (5) is a real number satisfying “μ=1/λ”.

$$SE [ m ] = μ * SD [ m ] \qquad ( 5 )$$

Subsequently, the point grant rate determination unit 12 generates annual number of collected cartridges prediction information DDF based on the annual demand prediction information DDA and the annual collection rate information DDD (S21).

Here, the annual number of collected cartridges prediction information DDF is information indicating a predicted value of the number of used cartridges 7 transferred to the recycling factory 9 in a predetermined period.

In the present embodiment, the annual number of collected cartridges prediction information DDF includes M pieces of number of collected cartridges prediction information DF[1] to DF[M] corresponding to the M unit periods. Among the M pieces of number of collected cartridges prediction information DF[1] to DF[M], number collections prediction information DF[m] is information indicating a number of collected cartridges predicted value SF[m], which is a predicted value of the number of used cartridges 7 transferred to the recycling factory 9 in the m-th unit period.

As explained above, in the present embodiment, it is assumed that, when the collecting action by the user UP is carried out in the m-th unit period, transfer of the used cartridge 7 collected by the collecting action to the recycling factory 9 is carried out in the (m+1)-th unit period. For this reason, in the present embodiment, in step S21, the point grant rate determination unit 12 generates the number of collected cartridges prediction information DF[m] based on the demand prediction information DA[m−1] included in the annual demand prediction information DDA and the collection rate information DD[m−1] included in the annual demand result information DD0. More specifically, in step S21, the point grant rate determination unit 12 calculates, as indicated by the following Expression (6), the number of collected cartridges predicted value SF[m] indicated by the number of collected cartridges prediction information DF[m] based on the demand predicted value SA[m−1] indicated by the demand prediction information DA[m−1] and the collection rate SD[m−1] indicated by the collection rate information DD[m−1].

$$S F [ m ] = SA [ m - 1 ] * SD [ m - 1 ] \qquad ( 6 )$$

Subsequently, the point grant rate determination unit 12 generates recycled product annual supply schedule information DDG based on the annual number of collected cartridges prediction information DDF (S23).

Here, the recycled product annual supply schedule information DDG is information indicating a scheduled value of a supply amount of the recycled product of the cartridge 7 to the market in a predetermined period.

In the present embodiment, the recycled product annual supply schedule information DDG includes M pieces of recycled product supply schedule information DG[1] to DG[M] corresponding to the M unit periods. Among the M pieces of recycled product supply schedule information DG[1] to DG[M], recycled product supply schedule information DG[m] is information indicating a recycled product supply scheduled value SG[m], which is a scheduled value of a supply amount of the recycled product of the cartridge 7 to the market in the m-th unit period.

As explained above, in the present embodiment, it is assumed that, when transfer of the used cartridge 7 to the recycling factory 9 is carried out in the m-th unit period, supply of a recycled product of the cartridge 7 obtained by recycling the used cartridge 7 to the market is carried out in the (m+1)-th unit period. For this reason, in the present embodiment, in step S23, the point grant rate determination unit 12 generates the recycled product supply schedule information DG[m] based on the number of collected cartridges prediction information DF[m−1] included in the annual number of collected cartridges prediction information DDF. Specifically, in step S23, the point grant rate determination unit 12 sets the number of collected cartridges predicted value SF[m−1] indicated by the number of collected cartridges prediction information DF[m−1] as the recycled product supply scheduled value SG[m] indicated by the recycled product supply schedule information DG[m] to generate the recycled product supply schedule information DG [m].

Subsequently, the point grant rate determination unit 12 generates recycled product annual shortage information DDH and recycled product annual excess information DDI based on the recycled product annual demand prediction information DDC and the recycled product annual supply schedule information DDG (S25).

The recycled product annual shortage information DDH is information indicating a shortage amount of supply of the recycled product of the cartridge 7 in a predetermined period.

In the present embodiment, the recycled product annual shortage information DDH includes M pieces of recycled product shortage information DH[1] to DH[M] corresponding to the M unit periods. Among the M pieces of recycled product shortage information DH[1] to DH[M], recycled product shortage information DH[m] is information indicating a recycled product shortage amount SH[m], which is a shortage amount of supply of the recycled product of the cartridge 7 in the m-th unit period.

In the present embodiment, in step S25, the point grant rate determination unit 12 generates the recycled product shortage information DH[m] based on the recycled product demand prediction information DC[m] included in the recycled product annual demand prediction information DDC and the recycled product supply schedule information DG[m] included in the recycled product annual supply schedule information DDG.

Specifically, in step S25, when the recycled product demand predicted value SC[m] indicated by the recycled product demand prediction information DC[m] is larger than the recycled product supply scheduled value SG[m] indicated by the recycled product supply schedule information DG[m], the point grant rate determination unit 12 sets a value obtained by subtracting the recycled product supply scheduled value SG[m] from the recycled product demand predicted value SC[m] as the recycled product shortage amount SH[m] to generate the recycled product shortage information DH[m].

In step S25, when the recycled product demand predicted value SC[m] indicated by the recycled product demand prediction information DC[m] is equal to or less than the recycled product supply scheduled value SG[m] indicated by the recycled product supply schedule information DG[m], the point grant rate determination unit 12 sets “0” to the recycled product shortage amount SH[m] to generate the recycled product shortage information DH[m].

The recycled product annual excess information DDI is information indicating an excess amount of the supply of the recycled product of the cartridge 7 in a predetermined period.

In the present embodiment, the recycled product annual excess information DDI includes M pieces of recycled product excess information DI[1] to DI[M] corresponding to the M unit periods. Among the M pieces of recycled product excess information DI[1] to DI[M], recycled product excess information DI [m] is information indicating recycled product excess amount SI[m], which is an excess amount of supply of the recycled product of the cartridge 7 in the m-th unit period.

In the present embodiment, in step S25, the point grant rate determination unit 12 generates the recycled product excess information DI[m] based on the recycled product demand prediction information DC[m] included in the recycled product annual demand prediction information DDC and the recycled product supply schedule information DG[m] included in the recycled product annual supply schedule information DDG.

Specifically, in step S25, when the recycled product supply scheduled value SG[m] indicated by the recycled product supply schedule information DG[m] is larger than the recycled product demand predicted value SC[m] indicated by the recycled product demand prediction information DC[m], the point grant rate determination unit 12 sets a value obtained by subtracting the recycled product demand predicted value SC[m] from the recycled product supply scheduled value SG[m] as the recycled product excess amount SI[m] to generate the recycled product excess information DI [m].

In step S25, when the recycled product supply scheduled value SG[m] indicated by the recycled product supply schedule information DG[m] is equal to or less than the recycled product demand predicted value SC[m] indicated by the recycled product demand prediction information DC[m], the point grant rate determination unit 12 sets “0” to the recycled product excess amount SI [m] to generate the recycled product excess information DI [m].

In the present embodiment, it is assumed that the point grant rate determination unit 12 generates the recycled product annual shortage information DDH and the recycled product annual excess information DDI in step S25. However, the present disclosure is not limited to such an aspect. The point grant rate determination unit 12 may generate one of the recycled product annual shortage information DDH and the recycled product annual excess information DDI in step S25.

Subsequently, the point grant rate determination unit 12 generates new product annual supply schedule information DDJ based on the new product annual demand prediction information DDB and the recycled product annual shortage information DDH (S27).

The new product annual supply schedule information DDJ is information indicating a scheduled value of a supply amount of a new product of the cartridge 7 to the market in a predetermined period.

In the present embodiment, the new product annual supply schedule information DDJ includes M pieces of new product supply schedule information DJ[1] to DJ[M] corresponding to the M unit periods. The new product supply schedule information DJ[m] is information indicating a new product supply scheduled value SJ[m], which is a scheduled value of a supply amount of the new product of the cartridge 7 to the market in the m-th unit period.

In the present embodiment, in step S27, the point grant rate determination unit 12 generates new product supply schedule information DJ[m] based on the new product demand prediction information DB[m] included in the new product annual demand prediction information DDB and the recycled product shortage information DH[m] included in the recycled product annual shortage information DDH. Specifically, in step S27, the point grant rate determination unit 12 sets a value obtained by adding up the new product demand predicted value SB[m] indicated by the new product demand prediction information DB[m] and the recycled product shortage amount SH[m] indicated by the recycled product shortage information DH[m] to the new product supply scheduled value SJ[m] to generate the new product supply schedule information DJ[m].

### 3. Numerical Value Examples

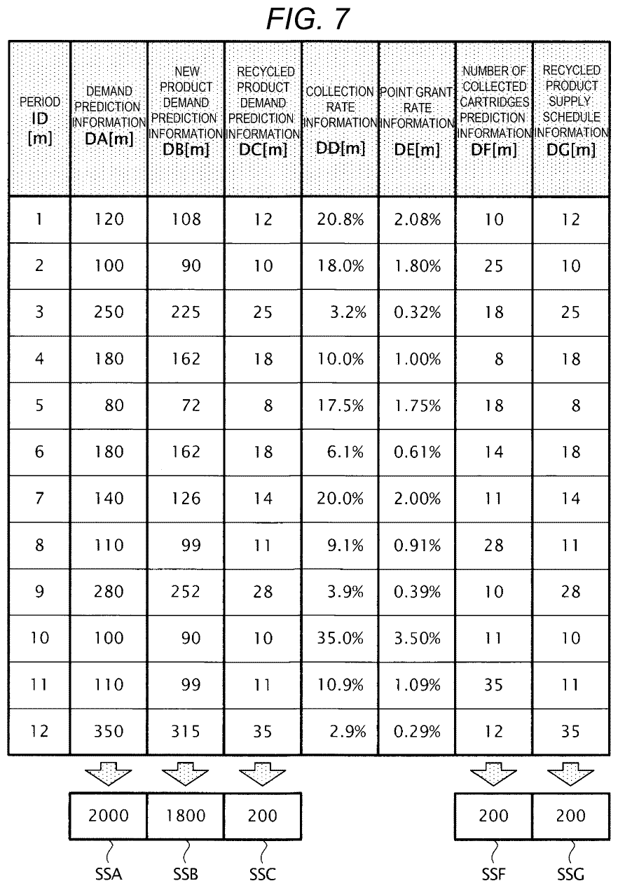

In the following explanation, numerical value examples of the point grant rate determination processing are explained with reference to FIGS. 7 to 10.

### 3.1. First Numerical Value Example

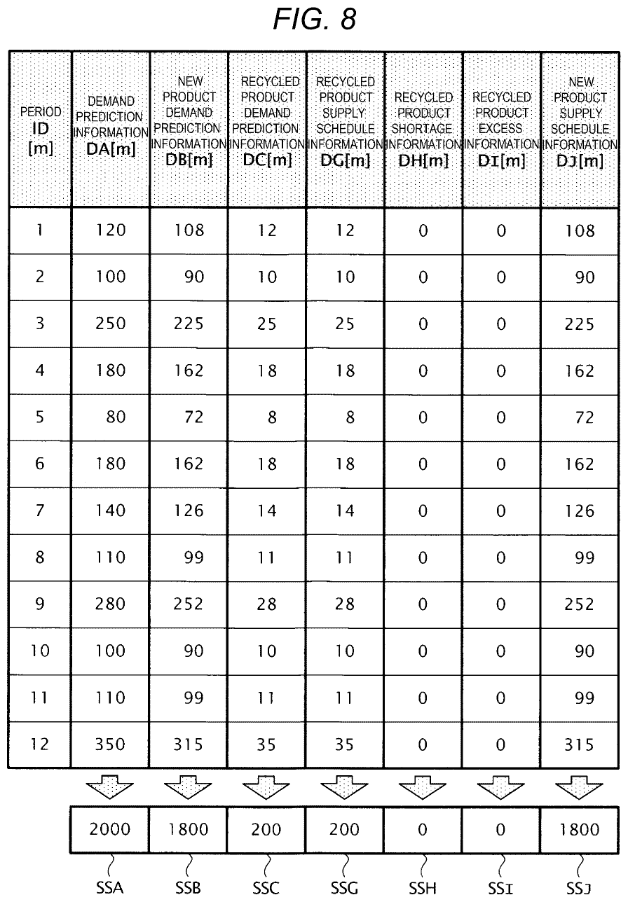

FIGS. 7 and 8 are diagrams illustrating numerical value examples of the point grant rate determination processing according to the present embodiment. In the following explanation, the numerical value examples illustrated in FIGS. 7 and 8 are referred to as “first numerical value example”.

In the first numerical value example, it is assumed that the value M is “12”. In the first numerical value example, it is assumed that the new product demand rate a is set to “0.9”, the value λ is set to “10”, and the value p is set to “0.1”.

As illustrated in FIGS. 7 and 8, in the first numerical value example, it is assumed that a total value SSA of demand predicted values SA[1] to SA[12] indicated by demand prediction information DA[1] to DA[12] included in the annual demand prediction information DDA is “2000”. In the first numerical value example, it is assumed that the demand predicted value SA[10] of October is “100” and the demand predicted value SA[12] of December is “350”. In the first numerical value example, it is assumed that, among the demand predicted values SA[1] to SA[12] from January to December, the demand predicted value SA[12](=“350”) of December is the maximum.

In the first numerical value example, the point grant rate determination unit 12 multiplies together the demand predicted value SA[12](=“350”) of December and the new product demand rate a (=“0.9”) to calculate a new product demand predicted value SB[12](=“315”) of December and multiplies together the demand predicted value SA[12](=“350”) of December and a value (=“0.1”) obtained by subtracting the new product demand rate a from “1” to calculate a recycled product demand predicted value SC[12](=“35”) of December.

In the first numerical value example, a total value SSB of new product demand predicted values SB[1] to SB[12] indicated by new product demand prediction information DB[1] to DB[12] included in the new product annual demand prediction information DDB is “1800”. In the first numerical value example, a total value SSC of recycled product demand predicted values SC[1] to SC[12] indicated by recycled product demand prediction information DC[1] to DC[12] included in the recycled product annual demand prediction information DDC is “200”.

In the first numerical value example, the point grant rate determination unit 12 divides the recycled product demand predicted value SC[12](=“35”) of December by the demand predicted value SA[10](=“100”) of October to calculate a collection rate SD[10](=“35%”) of October and multiplies together the collection rate SD[10](=“35%”) of October and the value p (=“0.1”) to calculate a point grant rate SE [10](=“3.5%”) of October.

In the first numerical value example, the point grant rate determination unit 12 multiplies together the demand predicted value SA[10](=“100”) of October and the collection rate SD[10](=“35%”) of October to calculate a number of collected cartridges predicted value SF[11](=“35”) of November and sets the calculated value to a recycled product supply scheduled value SG[12](=“35”) of December.

In the first numerical value example, a total value SSF of number of collected cartridges predicted values SF[1] to SF[12] indicated by number of collected cartridges prediction information DF[1] to DF[12] included in the annual number of collected cartridges prediction information DDF is “200”. In the first numerical value example, a total value SSG of recycled product supply scheduled values SG[1] to SG[12] indicated by recycled product supply schedule information DG[1] to DG[12] included in the recycled product annual supply schedule information DDG is “200”.

In the first numerical value example, since the recycled product demand predicted value SC[12](=“35”) of December and the recycled product supply scheduled value SG[12](=“35”) of December are equal, the point grant rate determination unit 12 sets “0” to the recycled product shortage amount SH[12] of December and sets “0” to the recycled product excess amount SI[12] of December.

In the first numerical value example, a total value SSH of recycled product shortage amounts SH[1] to SH[12] indicated by recycled product shortage information DH[1] to DH[12] included in the recycled product annual shortage information DDH is “0”. In the first numerical value example, each of the recycled product shortage amounts SH[1] to SH[12] is “0”.

In the first numerical value example, a total value SSI of recycled product excess amounts SI[1] to SI[12]indicated by recycled product excess information DI[1] to DI[12] included in the recycled product annual excess information DDI is “0”. In the first numerical value example, each of the recycled product excess amounts SI[1] to SI[12] is “0”.

In the first numerical value example, the point grant rate determination unit 12 sets a value obtained by adding up the new product demand predicted value SB[12](=“315”) of December and the recycled product shortage amount SH[12](=“O”) of December to a new product supply scheduled value SJ[12](=“315”) of December.

In the first numerical value example, a total value SSJ of new product supply scheduled values SJ[1] to SJ[12] indicated by new product supply schedule information DJ[1] to DJ[12] included in the new product annual supply schedule information DDJ is “1800”. In the first numerical value example, the new product supply scheduled value SJ[m] is a value equal to the new product demand predicted value SB [m].

As explained above, in the first numerical value example according to the present embodiment, since each of the recycled product shortage amounts SH[1] to SH[12] is set to “0”, the total value SSJ of the new product supply scheduled values SJ[1] to SJ[12] can be set to the same value as the total value SSB of the new product demand predicted values SB[1] to SB[12].

### 3.2. Second Numerical Value Example

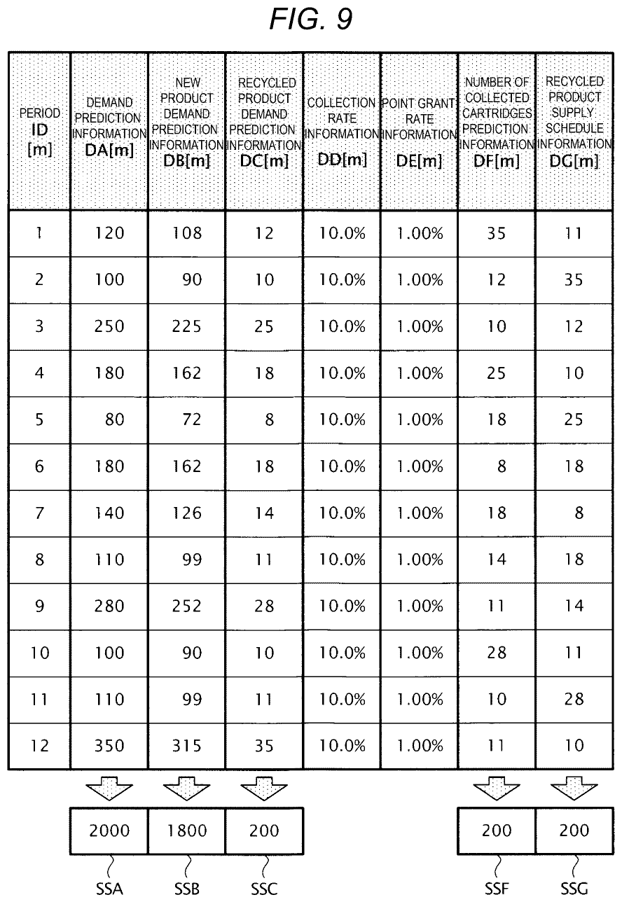

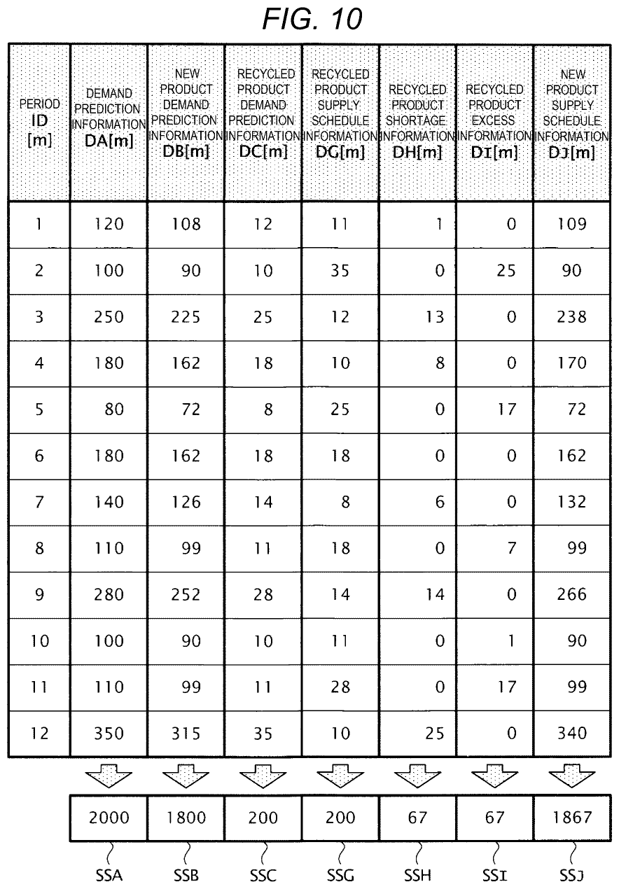

FIGS. 9 and 10 are diagrams illustrating numerical value examples of point grant rate determination processing according to a reference example. In the following explanation, the numerical value examples illustrated in FIGS. 9 and 10 are referred to as “second numerical value example”.

The point grant rate determination processing according to the reference example is different from the point grant rate determination processing in the embodiment in that the collection rate SD[m] indicated by the collection rate information DD[m] and the point grant rate SE[m] indicated by the point grant rate information DE[m] are fixed value S. Specifically, in the reference example, it is assumed that the collection rate SD[m] is fixed to “10.0%” and the point grant rate SE[m] is fixed to “1.0%”.

In the second numerical value example according to the reference example, it is assumed that the value M is “12” as in the first numerical value example. In the second numerical value example, as in the first numerical value example, it is assumed that the new product demand rate a is set to “0.9”, the value λ is set to “10”, and the value p is set to “0.1”.

As illustrated in FIGS. 9 and 10, in the second numerical value example, as in the first numerical value example, it is assumed that the total value SSA of the demand predicted values SA[1] to SA[12] indicated by the demand prediction information DA[1] to DA[12] included in the annual demand prediction information DDA is “2000”. In the second numerical value example, as in the first numerical value example, it is assumed that the demand predicted value SA[10] of October is “100” and the demand predicted value SA[12] of December is “350”.

In the second numerical value example, as in the first numerical value example, the point grant rate determination unit 12 multiplies together the demand predicted value SA[12](=“350”) of December and the new product demand rate a (=“0.9”) to calculate the new product demand predicted value SB[12](=“315”) of December and multiplies together the demand predicted value SA[12](=“350”) of December and a value (=“0.1”) obtained by subtracting the new product demand rate a from “1” to calculate the recycled product demand predicted value SC[12](=“35”) of December.

In the second numerical value example, as in the first numerical value example, the total value SSB of the new product demand predicted values SB[1] to SB[12] indicated by the new product demand prediction information DB[1] to DB[12] included in the new product annual demand prediction information DDB is “1800”.

In the second numerical value example, the point grant rate determination unit 12 multiplies together the demand predicted value SA[10](=“100”) of October and the collection rate SD[10](=“10%”) of October to calculate the number of collected cartridges predicted value SF[11](=“10”) of November and sets the calculated value to the recycled product supply scheduled value SG[12](=“10”) of December.

In the second numerical value example, the total value SSF of the number of collected cartridges predicted values SF[1] to SF[12] indicated by the number of collected cartridges prediction information DF[1] to DF[12] included in the annual number of collected cartridges prediction information DDF is “200”. In the second numerical value example, the total value SSG of the recycled product supply scheduled values SG[1] to SG[12] indicated by the recycled product supply schedule information DG[1] to DG[12] included in the recycled product annual supply schedule information DDG is “200”.

In the second numerical value example, the point grant rate determination unit 12 subtracts the recycled product supply scheduled value SG[12](=“10”) of December from the recycled product demand predicted value SC[12](=“35”) of December to calculate the recycled product shortage amount SH[12](=“25”) of December. In the second numerical value example, the point grant rate determination unit 12 sets “0” to the recycled product excess amount SI[12] of December.

In the second numerical value example, the total value SSH of the recycled product shortage amounts SH[1] to SH[12] indicated by the recycled product shortage information DH[1] to DH[12] included in the recycled product annual shortage information DDH is “67”. In the second numerical value example, the total value SSI of the recycled product excess amounts SI[1] to SI[12] indicated by the recycled product excess information DI[1] to DI[12] included in the recycled product annual excess information DDI is “67”.

In the second numerical value example, the point grant rate determination unit 12 sets a value obtained by adding up the new product demand predicted value SB[12](=“315”) of December to the recycled product shortage amount SH[12](=“25”) of December to the new product supply scheduled value SJ[12](=“340”) of December.

In the second numerical value example, the total value SSJ of the new product supply scheduled values SJ[1] to SJ[12] indicated by the new product supply schedule information DJ[1] to DJ[12] included in the new product annual supply schedule information DDJ is “1867”. In the first numerical value example, the new product supply scheduled value SJ[m] is sometimes a value different from the new product demand predicted value SB[m].

As explained above, in the reference example, as indicated by the second numerical value example, the recycled product shortage amount SH[m], which is “SH[m]>0”, is present in the recycled product shortage amounts SH[1] to SH[12] and the recycled product excess amount SI[m], which is “SI[m]>0”, is present in the recycled product excess amounts SI[1] to SI[12]. Therefore, a unit period in which a supply amount of the recycled product of the cartridge 7 is short and a unit period in which a supply amount of the recycled product of the cartridge 7 is excessive occur. For this reason, in the reference example, as indicated by the second numerical value example, it is necessary to set the total value SSJ “1867” of the new product supply scheduled values SJ[1] to SJ[12] larger than the total value SSB “1800” of the new product demand predicted values SB[1] to SB[12].

In contrast, in the present embodiment, as illustrated in the first numerical value example, compared with the second numerical value example, it is more likely that each of the recycled product shortage amounts SH[1] to SH[12] can be set to “0” and each of the recycled product excess amounts SI[1] to SI[12] can be set to “0”. Therefore, it is possible to make it less likely that the unit period in which the supply amount of the recycled product of the cartridge 7 is short and the unit period in which the supply amount of the recycled product of the cartridge 7 is excessive occur. For this reason, in the present embodiment, as indicated by the first numerical value example, compared with the second numerical value example, the total value SSJ “1800” of the new product supply scheduled values SJ[1] to SJ[12] can be set to a value closer to the total value SSB “1800” of the new product demand predicted values SB[1] to SB[12].

### 4. Point Grant Processing

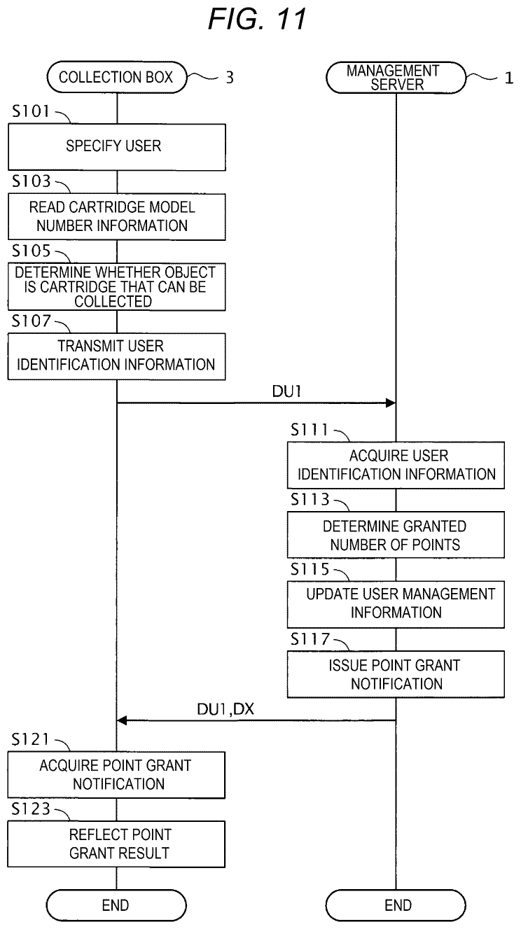

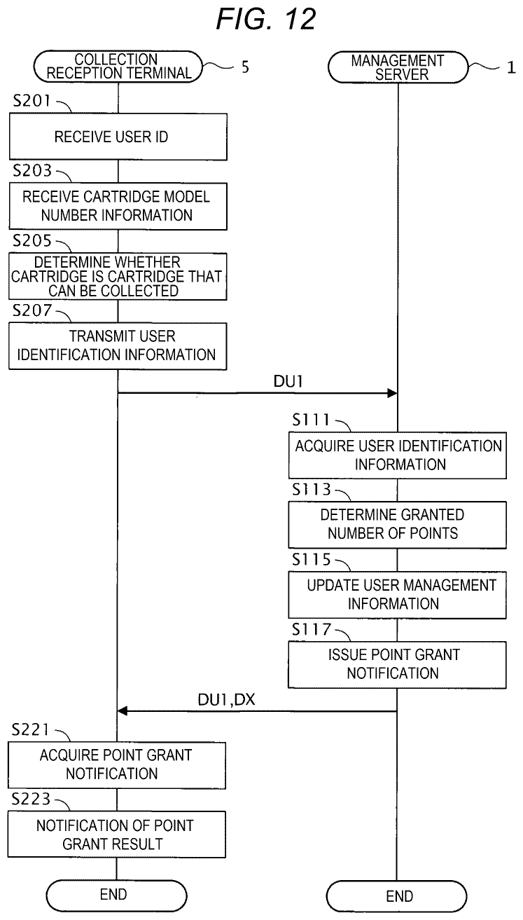

In the following explanation, an example of point grant processing is explained with reference to FIGS. 11 to 12. Here, the point grant processing is processing of granting points to the user UP. In the following explanation, the point grant processing executed by the management system Sys when the user UP performs a collecting action by the user bringing collection route RT1 is referred to as bringing time point grant processing. In the following explanation, the point grant processing executed by the management system Sys when the user UP performs a collecting action by the mailing collection route RT2 is referred to as mailing time point grant processing.

FIG. 11 is a sequence chart illustrating an example of an operation of the management system Sys in the case in which the management system Sys executes the bringing time point grant processing.

As illustrated in FIG. 11, in the bringing time point grant processing, when the user UP touches the user card information reading device 32 with the user card 8 and the user card information reading device 32 reads the user identification information DU1 from the storage device 80 provided in the user card 8, the user card authentication unit 37 of the collection box 3 specifies, based on the user identification information DU1, the user ID of the user UP who owns the user card 8 (S101).

Subsequently, when the user UP inserts the cartridge 7 into the cartridge insertion slot 30, the cartridge collection determination unit 36 of the collection box 3 controls the cartridge information reading device 31 to read information such as the cartridge model number information DQ1 stored in the storage device 70 provided in the cartridge 7 (S103).

Subsequently, the cartridge collection determination unit 36 of the collection box 3 determines, based on a reading result by the cartridge information reading device 31 in step S103, whether the object inserted into the cartridge insertion slot 30 corresponds to the cartridge 7 that can be collected by the collection box 3 (S105).

Subsequently, when a result of the determination in step S105 is affirmative, the control device 35 of the collection box 3 controls the communication device 33 to transmit the user identification information DU1 for identifying the user UP specified in step S101 to the management server 1 (S107).

Thereafter, the number of granted points determination unit 13 of the management server 1 acquires the user identification information DU1 transmitted by the control device 35 in step S107 (S111).

Subsequently, the number of granted points determination unit 13 of the management server 1 determines, based on the user identification information DU1 acquired by the number of granted points determination unit 13 in step S111 and the point grant rate information DE[m] generated in the point grant rate determination processing, the number of points granted to the user UP (S113).

Subsequently, the point grant unit 14 of the management server 1 grants a point to the user UP by updating, based on a determination result of the granted number of points determination unit 13 in step S113, the user management information DP corresponding to the user UP indicated by the user identification information DU1 acquired by the number of granted points determination unit 13 in step S111 (S115). Specifically, in step S115, the point grant unit 14 grants a point to the user UP indicated by the user identification information DU1 by updating, in the user management information DP, the number of points owned by the user UP indicated by the user identification information DU1, a history of points granted to the user UP indicated by the user identification information DU1, and a cumulative value of the points granted to the user UP indicated by the user identification information DU1.

Subsequently, the point grant unit 14 of the management server 1 issues a point grant notification (S117). Here, the point grant notification is a notification indicating that a point of the number of points determined by the number of granted points determination unit 13 in step S113 are granted to the user UP indicated by the user identification information DU1 acquired by the number of granted points determination unit 13 in step S111. Specifically, the point grant notification is information including the user identification information DU1 acquired by the number of granted points determination unit 13 in step S111 and the granted point information DX indicating the number of points determined by the number of granted points determination unit 13 in step S113.

Thereafter, the control device 35 of the collection box 3 acquires the point grant notification transmitted by the point grant unit 14 in step S117 (S121).

Subsequently, the control device 35 of the collection box 3 reflects a point grant result on the user card 8 (S123). Specifically, in step S123, the control device 35 controls the user card information reading device 32 to update, based on the point grant notification, the user owned point information DU2, the user cumulative point information DU3, and the point history information DU4 stored by the storage device 80 provided in the user card 8 of the user UP to reflect the point grant result on the user card 8.

FIG. 12 is a sequence chart illustrating an example of an operation of the management system Sys in the case in which the management system Sys executes the mailing time point grant processing. In the present embodiment, it is assumed that the collection reception terminal 5 provided in the collection center FE has functions equivalent to the functions of the cartridge information reading device 31, the communication device 33, and the control device 35 provided in the collection box 3. In the present embodiment, it is assumed that, when the user UP has performed the collecting action by the mailing collection route RT2, the user ID for uniquely identifying the user UP is described in the collection application AP enclosed in the mail ML to the collection center FE.

As illustrated in FIG. 12, when the staff member UE of the collection center FE inputs, to the collection reception terminal 5, the user ID described in the collection application AP enclosed in the mail ML from the user UP, the collection reception terminal 5 receives the user ID and generates the user identification information DU1 indicating the user ID (S201).

Subsequently, the staff member UE of the collection center FE reads, using a not-illustrated reading device, the cartridge model number information DQ1 stored in the storage device 70 provided in the cartridge 7 enclosed by the mail ML from the user UP. Then, the collection reception terminal 5 receives the cartridge model number information DQ1 read by the reading device (S203).

Subsequently, based on the cartridge model number information DQ1 received in step S203, the collection reception terminal 5 determines whether the cartridge 7 enclosed in the mail ML from the user UP corresponds to the cartridge 7 that can be collected by the collection center FE (S205).

Subsequently, when a result of the determination in step S205 is affirmative, the collection reception terminal 5 transmits the user identification information DU1 indicating the user ID received in step S201 to the management server 1 (S207).

Thereafter, the management server 1 executes the processing in steps S111 to S117 explained above.

Thereafter, the collection reception terminal 5 acquires the point grant notification transmitted by the point grant unit 14 in step S117 (S221).

Then, the collection reception terminal 5 notifies the point grant result to the user UP using communication means such as an e-mail (S223).

### 5. Conclusion of the Embodiment

As explained above, the management server 1 according to the present embodiment is the management server 1 that manages the cartridge 7 that stores the ink used in the printing apparatus PR, the management server 1 including the point grant unit 14 that grants a point of an amount corresponding to the point grant rate SE[m1] to the user UP who has performed the collecting action for collecting the cartridge 7 in an m1-th unit period and grants a point of an amount corresponding to the point grant rate SE[m2] to the user UP who has performed the collecting action for collecting the cartridge 7 in an m2-th unit period.

Here, the variable m1 is a natural number that satisfies “1≤m1≤M” and the variable m2 is a natural number that satisfies “1≤m2≤M” and “m1≠m2”. In the present embodiment, the m1-th unit period is an example of a “first period”, the m2-th unit period is an example of a “second period”, the amount corresponding to the point grant rate SE[m1] is an example of a “first amount”, and the amount corresponding to the point grant rate SE[m2] is an example of a “second amount”.

As explained above, according to the present embodiment, the management server 1 changes the amount of the point granted to the user UP who has performed the collecting action of collecting the cartridge 7. For this reason, according to the present embodiment, it is possible to more flexibly control a collected amount of the used cartridge 7 from the user UP compared with an aspect in which a point is not granted to the user UP and an aspect in which an amount of a point granted to the user UP is fixed. As a result, in the present embodiment, it is possible to more appropriately control a balance between supply of the cartridge 7 manufactured as the recycled product and demand for the cartridge 7 in comparison with the aspect in which a point is not granted to the user UP and the aspect in which an amount of a point granted to the user UP is fixed. That is, in the present embodiment, it is possible to increase a ratio of the recycled product of the cartridge 7 to demand for the cartridge 7 compared with the aspect in which a point is not granted to the user UP and the aspect in which an amount of a point granted to the user UP is fixed.

Thus, according to the present embodiment, compared to the aspect in which a point is not granted to the user UP and the aspect in which an amount of a point granted to the user UP is fixed, it is possible to more greatly contribute to “significantly reducing occurrence of wastes through occurrence prevention, reduction, recycled use, and reuse of the wastes” described in the target 12.5 of the SDGs.

Further, in the present embodiment, the management server 1 includes the point determination unit 19 that determines the point grant rate SE[m1] and the point grant rate SE[m2] according to the predicted amount of the demand for the cartridge 7 indicated by the annual demand prediction information DDA.

As explained above, according to the present embodiment, the management server 1 determines, according to a predicted amount of demand for the cartridge 7, an amount of a point granted to the user UP. For this reason, according to the present embodiment, it is possible to increase a ratio of the recycled product of the cartridge 7 to the demand for the cartridge 7 compared with the aspect in which a point is not granted to the user UP and the aspect in which an amount of a point granted to the user UP is fixed.

Thus, according to the present embodiment, compared to the aspect in which a point is not granted to the user UP and the aspect in which an amount of a point granted to the user UP is fixed, it is possible to more greatly contribute to “significantly reducing occurrence of wastes through occurrence prevention, reduction, recycled use, and reuse of the wastes” described in the target 12.5 of the SDGs.

In the present embodiment, a demand predicted value SA[m3], which is a predicted amount of demand for the cartridge 7 in an m3-th unit period in which the recycled product of the cartridge 7 remanufactured using the cartridge 7 collected in the m1-th unit period is supplied, is larger than a demand predicted value SA[m4], which is a predicted amount of demand for the cartridge 7 in an m4-th unit period in which the recycled product of the cartridge 7 remanufactured using the cartridge 7 collected in the m2-th unit period is supplied, and the number of points corresponding to the point grant rate SE[m1] is larger than the number of points corresponding to the point grant rate SE [m2].

Here, the m3-th unit period is an example of a “first supply period” and the m4-th unit period is an example of a “second supply period”.

For example, in the first numerical value example, the demand predicted value SA[12](=“350”), which is the predicted amount of the demand for the cartridge 7 in December when the recycled product of the cartridge 7 remanufactured using the cartridge 7 collected in October is supplied, is larger than the demand predicted value SA[11](=“110”), which is the predicted amount of the demand for the cartridge 7 in November when the recycled product of the cartridge 7 remanufactured using the cartridge 7 collected in September is supplied, and the number of points corresponding to the point grant rate SE[10](=“3.5%”) is larger than the number of points corresponding to the point grant rate SE[9](=0.39%).

As explained above, according to the present embodiment, the management server 1 determines, according to a predicted amount of demand for the cartridge 7, an amount of a point granted to the user UP. For this reason, according to the present embodiment, it is possible to increase a ratio of the recycled product of the cartridge 7 to the demand for the cartridge 7 compared with the aspect in which a point is not granted to the user UP and the aspect in which an amount of a point granted to the user UP is fixed.

Thus, according to the present embodiment, compared to the aspect in which a point is not granted to the user UP and the aspect in which an amount of a point granted to the user UP is fixed, it is possible to more greatly contribute to “significantly reducing occurrence of wastes through occurrence prevention, reduction, recycled use, and reuse of the wastes” described in the target 12.5 of the SDGs.

In the present embodiment, the m3-th unit period is a period in which demand for the ink used in the printing apparatus PR is the largest in a predetermined period and the m1-th unit period is a period in which an amount of a point granted to the user UP who has performed the collecting action is the largest in the predetermined period.

For example, in the first numerical value example, December is a period in which the demand for the ink used in the printing apparatus PR is the largest in a year and October is a period in which an amount of a point granted to the user UP who has performed the collecting action is the largest in the year.

As explained above, according to the present embodiment, the management server 1 specifies, according to a period in which demand for the cartridge 7 is the largest, a period in which an amount of a point granted to the user UP is the largest. For this reason, according to the present embodiment, it is possible to increase a ratio of the recycled product of the cartridge 7 to the demand for the cartridge 7 compared with the aspect in which a point is not granted to the user UP and the aspect in which an amount of a point granted to the user UP is fixed.

Thus, according to the present embodiment, compared to the aspect in which a point is not granted to the user UP and the aspect in which an amount of a point granted to the user UP is fixed, it is possible to more greatly contribute to “significantly reducing occurrence of wastes through occurrence prevention, reduction, recycled use, and reuse of the wastes” described in the target 12.5 of the SDGs.

In the present embodiment, a point is a right of obtaining the recycled product of the cartridge 7 remanufactured using the cartridge 7 collected by the collecting action.

As explained above, according to the present embodiment, a point for enabling acquisition of the used cartridge 7 is granted to the user UP to give motivation for reuse of the cartridge 7 to the user UP. Thus, according to the present embodiment, compared with the aspect in which a point is not granted to the user UP and the aspect in which an amount of a point granted to the user UP is fixed, it is possible to more strongly enlighten the user UP about the necessity of collecting the cartridge 7.

Thus, according to the present embodiment, compared with the aspect in which a point is not granted to the user UP and the aspect in which an amount of a point granted to the user UP is fixed, it is possible to more greatly contribute to “improving education, enlightenment, human capacity, and institutional functions concerning climate change mitigation, adaptation, impact reduction, and early warning” described in the target 13.3 of the SDGs.

In the present embodiment, the point grant unit 14 manages the user management information DP relating to a history of the collecting action by the user UP and determines, based on the user management information DP, an amount of a point granted to the user UP.

As explained above, according to the present embodiment, an amount of a point granted to the user UP is determined based on the history of the collecting action by the user UP. For this reason, according to the present embodiment, compared with an aspect in which a history of the collecting action by the user UP is not considered in granting a point to the user UP, motivation for reuse of the cartridge 7 can be given to the user UP over a longer period.

Thus, according to the present embodiment, compared with the aspect in which a point is not granted to the user UP and the aspect in which an amount of a point granted to the user UP is fixed, it is possible to more greatly contribute to “improving education, enlightenment, human capacity, and institutional functions concerning climate change mitigation, adaptation, impact reduction, and early warning” described in the target 13.3 of the SDGs.

In the present embodiment, the collecting action is an action of bringing the cartridge 7 into the collection box 3 or the collection center FE, and the collection box 3 and the collection center FE are capable of collecting the cartridge 7 in both a case in which the ink does not remain in the ink chamber of the cartridge 7 and a case in which the ink remains in the ink chamber of the cartridge 7.

As explained above, according to the present embodiment, since the cartridge 7 can be collected even when the ink remains in the cartridge 7, it is possible to reduce possibility of environmental pollution caused by inappropriate disposal of the ink by the user UP compared with an aspect in which the cartridge 7 can be collected only when the ink does not remain in the cartridge 7.

Thus, according to the present embodiment, compared with the aspect in which the cartridge 7 can be collected only when the ink does not remain the cartridge 7, it is possible to more greatly contribute to “reducing the numbers of deaths and diseases due to hazardous chemicals and air, water, and soil pollution” described in the target 3.9 of the SDGs.

According to the present embodiment, compared with aspect in which the cartridge 7 can be collected only when the ink does not remain in the cartridge 7, it is possible to more greatly contribute to “improvement of water quality through minimization of emission of hazardous chemicals” described in the target 6.3 of the SDGs.

### B. Modifications

The embodiment explained above can be variously modified. Aspects of specific modifications are exemplified below. Two or more aspects optionally selected from the following exemplifications can be combined as appropriate in a range in which the aspects do not contradict each other. In the modifications exemplified below, elements having the same actions and functions as those of the embodiment are denoted by the same reference numerals and signs referred to in the above explanation, and detailed explanation of the respective elements is omitted as appropriate.

### Modification 1

In the embodiment explained above, for convenience of description, the aspect in which the management server 1 generates the annual demand prediction information DDA, the new product annual demand prediction information DDB, the recycled product annual demand prediction information DDC, the annual collection rate information DDD, the annual point grant information DDE, the annual number of collected cartridges prediction information DDF, the recycled product annual supply schedule information DDG, the recycled product annual shortage information DDH, the recycled product annual excess information DDI, and the new product annual supply schedule information DDJ based on the annual demand result information DD0 in the point grant rate determination processing is exemplified and explained. However, the present disclosure is not limited to such an aspect. In the point grant rate determination processing, the management server 1 only has to generate at least the annual point grant information DDE based on the annual demand result information DD0. For example, in the point grant rate determination processing, the management server 1 may execute only the processing in steps S11 to S19 in the processing in steps S11 to S27 illustrated in FIG. 6.

### Modification 2

In the embodiment and the modification 1 explained above, the case in which the cartridge 7 includes the storage device 70 storing the cartridge model number information DQ1 is exemplified and explained. However, the present disclosure is not limited to such an aspect. For example, the cartridge 7 may include a symbol for representing the cartridge model number information DQ1. Here, the symbol may be a display object having a pattern for representing the cartridge model number information DQ1. More specifically, the symbol may be a two-dimensional code for representing the cartridge model number information DQ1 or may be a one-dimensional code for representing the cartridge model number information DQ1.

When the cartridge 7 includes the symbol, the cartridge information reading device 31 may be an imaging device that images the symbol or may be an image processing device for reading the cartridge model number information DQ1 from the symbol.

As explained above, according to the present modification, the collection box 3 determines, based on the symbol provided in the cartridge 7, whether a product brought into the collection box 3 is the cartridge 7 to be collected by the collection box 3. Therefore, it is possible to more easily discriminate the cartridge 7 compared with aspects of the related art such as an aspect in which a person having a specific technique capable of discriminating a type of the cartridge 7 is disposed and an aspect in which a specific sensor device capable of discriminating the type of the cartridge 7 is disposed.

Thus, according to the present embodiment, compared with the aspect in which the person having the specific technique or the specific sensor device is disposed as in the related art, it is possible to greatly contribute to “promoting comprehensive and sustainable industrialization and increasing employment” in the industrial field relating recycling as described in the target 9.2 of SDGs.

### Modification 3

In the embodiment and the modifications 1 and 2 explained above, the case in which the cartridge information reading device 31 reads the cartridge model number information DQ1 from the cartridge 7 is exemplified and explained. However, the present disclosure is not limited to such an aspect.

For example, the cartridge information reading device 31 may be an image analysis device that reads the shape of the cartridge 7. In this case, the cartridge collection determination unit 36 may determine, based on the shape of the cartridge 7 read by the cartridge information reading device 31, whether a product brought into the collection box 3 is the cartridge 7 that can be collected by the collection box 3.

For example, the cartridge information reading device 31 may be an imaging device that images the cartridge 7. In this case, the cartridge collection determination unit 36 may determine, based on an imaging result by the cartridge information reading device 31, whether the product brought into the collection box 3 is the cartridge 7 that can be collected by the collection box 3.

### Modification 4

In the embodiment and the modifications 1 to 3 explained above, the case in which the management server 1 grants a point to the user UP when the user UP has performed the collecting action and grants a point to the user UP when the cumulative acquired point of the user UP satisfies the specific condition is exemplified and explained. However, the present disclosure is not limited to such an aspect.

For example, when the user UP has performed the collecting action, the management server 1 may determine, based on the number of times the cartridge 7 to be subjected to the collecting action is recycled as a recycled product of the cartridge 7, a point granted to the user UP.

Further, for example, when the user UP has performed the collecting action, the management server 1 may determine, based on a manufacturing date of the cartridge 7 to be subjected to the collecting action, a point granted to the user UP.

### Modification 5

In the embodiment and the modifications 1 to 4 explained above, the management server 1 grants a point to the user UP, for example, when the user UP has performed the collecting action. However, the present disclosure is not limited to such an aspect. For example, when the user UP has performed the collecting action, the management server 1 may improve a grant rate of a point granted to the user UP. That is, in the present modification, the improvement of the point grant rate is an example of the “privilege”.

In the present disclosure, the “privilege” is not limited to the point, the improvement of the point grant rate, and the like. The “privilege” may be, for example, a tangible object or an intangible object having a value for the user UP such as money or a gift certificate or may be an object that motivates the user UP to perform the collecting action.

### Modification 6

In the embodiment and the modifications 1 to 5 explained above, the aspect in which an amount of a privilege such as a point is determined according to the unit period, that is, the aspect in which an amount of a privilege granted to the user UP who has performed the collecting action in one unit period and an amount of a privilege granted to the user UP who has performed the collecting action in another unit period are different is exemplified and explained. However, the present disclosure is not limited to such an aspect.

For example, the management server 1 may change a type of a privilege according to the unit period. Specifically, the management server 1 may grant a privilege of a first type to the user UP who has performed the collecting action in one unit period and grant a privilege of a second type different from the privilege of the first type to the user UP who has performed the collecting action in another unit period. Here, for example, when the collection rate SD[m] calculated in one unit period is large, collection of a larger number of cartridges 7 is necessary in one unit period, the collection rate SD[m] calculated in another unit periods is small, and necessity of collection of the cartridge 7 is low in the other unit period, it is preferable that the privilege of the first type is a privilege that more strongly motivates the user UP to perform the collecting action or a privilege that is more beneficial for the user UP compared with the privilege of the second type.

### Modification 7

In the embodiment and the modifications 1 to 6 explained above, the cartridge 7 is exemplified and explained as the specific member that is the target of the collecting action. However, the present disclosure is not limited to such an aspect. The target of the collecting action in the management system Sys only has to be a reusable specific member.

Here, the specific member may be, for example, besides the cartridge 7 that stores the ink serving as the consumable item, a storage container that stores a consumable item used in the printing apparatus PR such as a toner bottle that stores toner serving as a consumable item. The specific member may be, for example, a storage container that stores a waste that occurs according to use of the printing apparatus PR such as a waste ink box that stores waste ink serving as a waste or a waste toner box that stores waste toner serving as a waste.

Further, the specific member is not limited to a member relating to the printing apparatus PR. For example, the specific member may be a member that can be reused by replacing a consumable item such as a projector including a lamp serving as a consumable item and a smartphone including a battery serving as a consumable item.

Further, the specific member is not limited to the member that can be reused by replacing the consumable item. For example, the specific member may be a member that can be reused by being disassembled into materials such as clothing composed of a fabric serving as a material and printing paper composed of a fiber serving as a material.

What is claimed is:

1. A control method for a management device that manages a storage container that stores a consumable item used in a printing apparatus, the method causing a processor of the management device to function as a granting unit configured to:
grant a privilege of a first amount to a user who performed a collecting action for collecting the storage container in a first period; and
grant the privilege of a second amount different from the first amount to the user who performed the collecting action in a second period different from the first period.

2. The control method according to claim 1, further causing the processor of the management device to function as a determination unit configured to determine the first amount and the second amount according to a predicted amount of demand for the consumable item.

3. The control method according to claim 1, wherein
a predicted amount of demand for the consumable item in a first supply period in which a recycled product of the storage container remanufactured using the storage container collected in the first period is supplied is larger than the predicted amount of the demand for the consumable item in a second supply period in which the recycled product of the storage container remanufactured using the storage container collected in the second period is supplied, and
the first amount is larger than the second amount.

4. The control method according to claim 3, wherein
the first supply period is a period in which the demand for the consumable item used in the printing apparatus is largest in a year, and
the first period is a period in which an amount of the privilege granted to the user who performed the collecting action is largest in the year.

5. The control method according to claim 1, wherein the privilege is a right to obtain a recycled product of the storage container remanufactured using the storage container collected by the collecting action.

6. The control method according to claim 1, wherein the granting unit manages history information concerning a history of the collecting action by the user, and determines, based on the history information, an amount of the privilege granted to the user.

7. The control method according to claim 1, wherein
the collecting action is an action of bringing the storage container into collection equipment for collecting the storage container, and
the collection equipment is capable of collecting the storage container in both of a case in which the consumable item does not remain in the storage container and a case in which the consumable item remains in the storage container.

8. A management system that manages a reusable specific member, the management system comprising a granting unit configured to:
grant a privilege of a first amount to a user who performed a collecting action for collecting the specific member in a first period; and
grant the privilege of a second amount different from the first amount to the user who performed the collecting action in a second period different from the first period.

9. The management system according to claim 8, further comprising a determination unit configured to determine the first amount and the second amount according to a predicted amount of demand for the specific member.

10. The management system according to claim 8, wherein
a predicted amount of demand for the specific member in a first supply period in which a recycled product of the specific member remanufactured using the specific member collected in the first period is supplied is larger than the predicted amount of the demand for the specific member in a second supply period in which the recycled product of the specific member remanufactured using the specific member collected in the second period is supplied, and
the first amount is larger than the second amount.

11. The management system according to claim 10, wherein
the first supply period is a period in which the demand for the specific member is largest in a year, and
the first period is a period in which an amount of the privilege granted to the user who performed the collecting action is largest in the year.

12. The management system according to claim 8, wherein the privilege is a right to obtain a recycled product of the specific member remanufactured by using the specific member collected by the collecting action.

13. The management system according to claim 8, wherein the granting unit manages history information concerning a history of the collecting action by the user and determines, based on the history information, an amount of the privilege granted to the user.
